(19) United States
(12) Patent Application Publication
(10) Pub. No.: US 2026/0230844 A1
(43) Pub. Date: Aug. 6, 2026

(54) METHODS FOR CONSISTENT AI/ML BASED POSITIONING IN TIME VARYING ENVIRONMENTS

(71) Applicant: InterDigital Patent Holdings, Inc., Wilmington, DE (US)

(72) Inventors: Fumihiro Hasegawa, Westmount (CA); Yugeswar Deenoo Narayanan Thangaraj, Chalfont, PA (US); Dylan Watts, Montreal (CA); Moon IL Lee, Melville, NY (US); Shahab Hamidi-Rad, Sunnyvale, CA (US); Patrick Tooher, Montreal (CA); Benoit Pelletier, Roxboro (CA)

(73) Assignee: InterDigital Patent Holdings, Inc., Wilmington, DE (US)

(21) Appl. No.: 19/044,414

(22) Filed: Feb. 3, 2025

(51) Int. Cl. H04W 24/02; H04W 24/10

(52) U.S. Cl. CPC H04W 24/02; H04W 24/10

(57) ABSTRACT

A wireless transmit/receive unit (WTRU) may receive a first associated identifier (ID) function and/or one or more validation conditions. The first associated ID function may be associated with a set of time-varying characteristics of a first non-terrestrial network (NTN) communication channel. The WTRU may determine whether the one or more validation conditions are satisfied. The WTRU may determine a first set of values associated with the first associated ID function and based on the one or more validation conditions being satisfied. The first associated ID function may be associated with a first time period of an AI/ML model. The WTRU may determine a second set of values associated with the first associated ID function and based on the one or more validation conditions being satisfied. The first associated ID function may be associated with a second time period of the AI/ML model. The WTRU may send a report.

### BACKGROUND

Artificial intelligence or machine learning (AI/ML) based positioning may use fingerprints in measurements. It is assumed that the UE make measurements on PRSs transmitted from satellites. A user equipment (UE), also known as a wireless transmit/receive unit (WTRU) may make measurements on positioning reference signals (PRSs) transmitted from satellites. Based on the measurements, the WTRU may train the AI/ML model(s) at the WTRU. Consistency may need to be achieved between training and inference. Time varying environmental conditions may change PRS characteristics.

The WTRU may send a request to the network for configuration (e.g., downlink reference signal (DL-RS) configurations and/or uplink reference signal UL-RS configurations) in physical uplink shared channel (PUSCH), physical uplink control channel (PUCCH), uplink control information (UCI), medium access control (MAC) control element (CE), radio resource control (RRC), and/or an long term evolution (LTE) positioning protocol (LPP) message. The request from the WTRU may include configurations of a measurement gap, DL-RS processing window, and/or window for transmission of UL-RS. The WTRU may send an acknowledgement message in PUSCH and/or PUCCH for the grant received from the network. More than one conditions and/or criteria may be used in a combination. The WTRU may be configured with more than one conditions and/or associated WTRU behavior. The WTRU may determine which behavior the WTRU shall use based on the applicable condition. The WTRU may measure DL-RS inside and/or outside of an active bandwidth part (BWP). The WTRU may transmit UL-RS inside and/or outside of active BWP. The WTRU may be preconfigured with parameters (e.g., measurement gaps, DL-RS processing windows, DL-RS configurations, and/or UL-RS configurations) via a semi-static message (e.g., LPP and/or RRC). The WTRU may report measurements and/or configuration parameters in a semi-static message (e.g., LPP and/or RRC) and/or dynamic message (e.g., UCI and/or MAC-CE). The network may configure any actions the WTRU determines to take. For example, the WTRU may be configured with a rule. According to the rule, the WTRU may determine to take an associated action. In addition to the measurements made on DL-RS, the WTRU may include at least one of the following cell-related measurements: synchronization signal block (SSB) reference signal received power (RSRP) from the serving cell with corresponding cell identifier (ID), SSB RSRP from the neighboring cell(s) with corresponding cell ID(s), RSRP of channel state information (CSI)-RS with CSI-RS resource ID, and/or RSRP of a demodulation reference signal (DM-RS).

### SUMMARY

A wireless transmit/receive unit (WTRU) may receive a first associated identifier (ID) and/or one or more validation conditions. The first associated ID may be associated with a first set of time-varying characteristics of a first non-terrestrial network (NTN) communication channel. The WTRU may determine whether the one or more validation conditions are satisfied. The WTRU may determine a first set of values associated with the first associated ID function and based on the one or more validation conditions being satisfied. The first associated ID function may be associated with a first time period (of an artificial intelligence or machine learning (AI/ML) model. The WTRU may determine a second set of values associated with the first associated ID function and based on the one or more validation conditions being satisfied. The first associated ID function may be associated with a second time period of the AI/ML model. The WTRU may send a report. The report may indicate that the first set of values were used during the first time period of the AI/ML model and/or that the second set of values were used during the second time period of the AI/ML model. The report may indicate a consistency between conditions of the first set of values and the second set of values. The report may indicate a comparison between the first set of values and the second set of values. The WTRU may determine, if the one or more validation conditions are satisfied, the difference of a value of the first set of values and a value of the second set of values. The WTRU may determine a third value based on the difference between the value of the first set of values and the value of the second set of values. The WTRU may send the third value with the report. The third value may be the indication of the comparison between the first set of values and the second set of values.

The WTRU may send an indication to the network that the first associated ID function is no longer valid or that the one or more validation conditions are not satisfied. The WTRU may receive a second associated ID function in response to the indication.

The WTRU may send an indication to the network that the first associated ID is no longer valid and/or that the one or more validation conditions are not satisfied. The WTRU may receive reconfigured parameters for the first associated ID function. The WTRU may generate a second associated ID function based on the first associated ID function and the reconfiguration parameters

The set of time-varying characteristics may comprise one or more of transmit reception points (TRPs), atmospheric conditions, weather conditions, power sharing, and/or the network energy saving (NES) status of a satellite.

The validation conditions may comprise one or more of the difference between two values of the first set of values exceeding a threshold, measurements of downlink reference signals (DL-RS) exceeding a threshold, a validity area associated with the first associated ID function, and/or a request from a network device to generate an inference under the first associated ID function.

The WTRU may receive a first set of a plurality of associated ID functions. The first associated ID function may be one of the first set of a plurality of associated ID functions and/or each associated ID function of the first set of plurality of associated IDs may be associated with a respective set of time-varying characteristics of the first NTN communication channel. The WTRU may determine a priority level for each associated ID of the first set of plurality of associated ID functions. The WTRU may select a first associated ID function based on the determined priority level.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 depicts the different interfaces in a non-terrestrial network (NTN).

FIG. 3 depicts a diagram of an artificial intelligence or machine learning (AI/ML) model to estimate wireless transmit/receive unit (WTRU) location.

FIG. 4 is a diagram depicting the ephemeris of moving satellites.

FIG. 5 depicts diagrams of atmospheric interfered conditions on satellites.

FIG. 6 depicts different channel conditions between data collection and inference phases.

FIG. 7 depicts a time varying associated identifier (ID).

FIG. 8 depicts is a diagram depicting the trajectory of a satellite over time.

FIG. 9 depicts timing occasions and measurements to make to verify an associated ID.

FIG. 10 depicts time varying associated ID values.

FIG. 11 depicts both the data collection phase and the inference phase covering more than one associated ID.

FIG. 12 depicts a call flow indicating signaling between the WTRU and the network.

### DETAILED DESCRIPTION

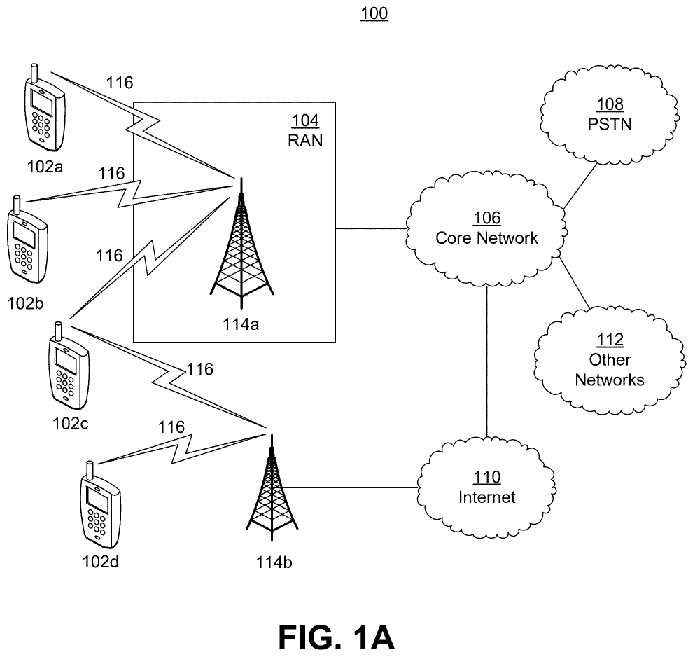

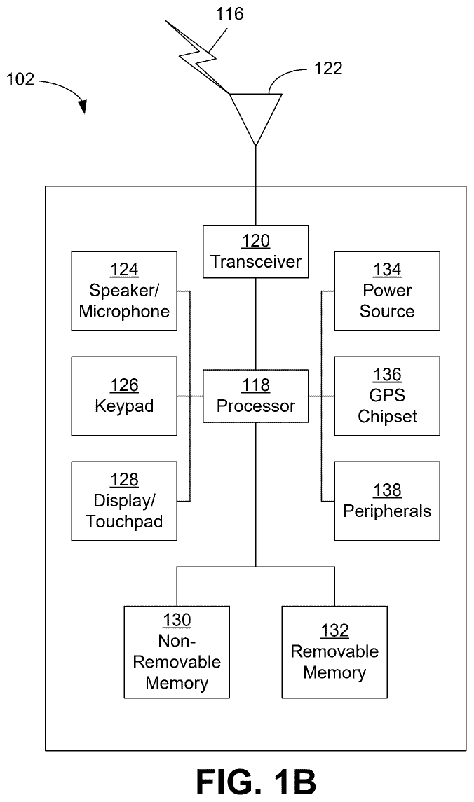

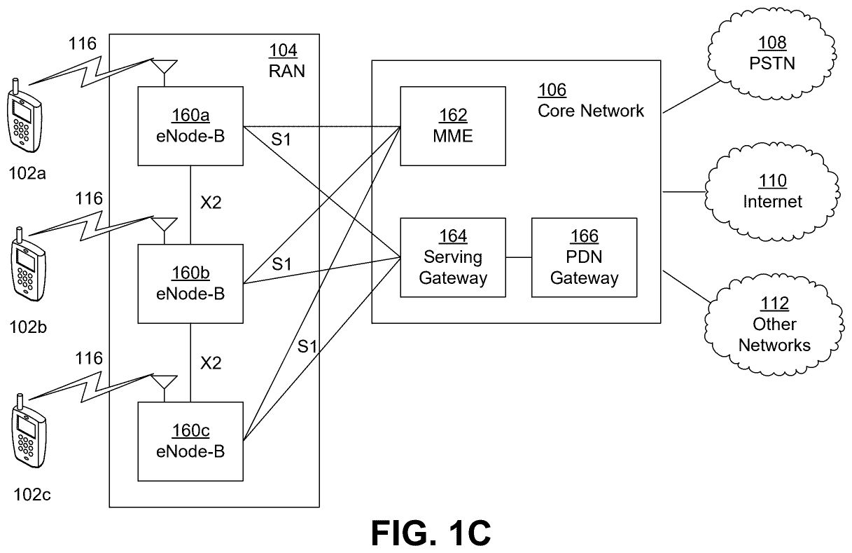

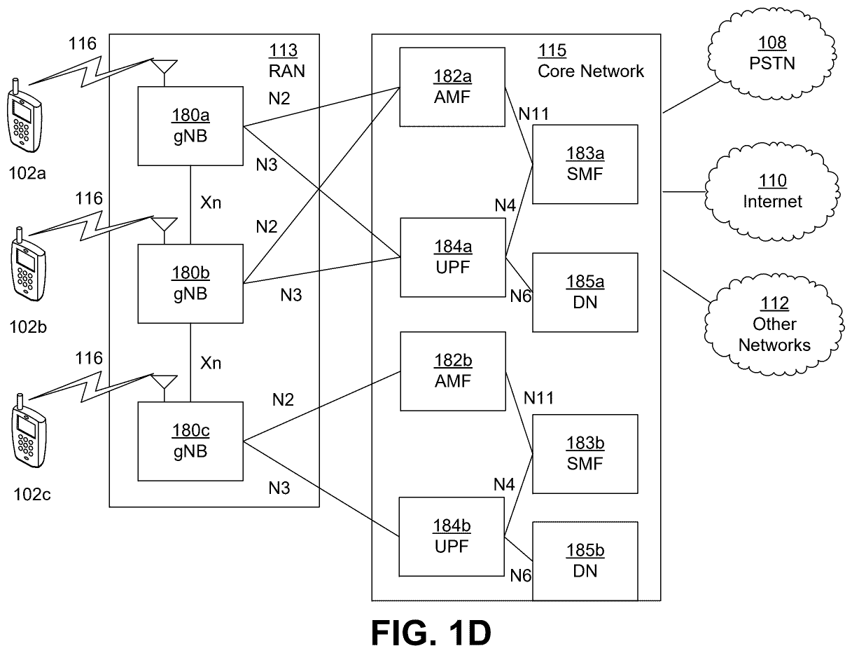

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

As disclosed herein, “network” may include an access and management mobility function (AMF), a location management function (LMF), gNB or next generation radio access network (NG-RAN). “Pre-configuration” and “configuration” may be used interchangeably herein. “Non-serving gNB” and “neighboring gNB” may be used interchangeably herein. “gNB” and “TRP” may be used interchangeably herein. “DL-RS” and “DL-RS resource” may be used interchangeably herein. “DL-RS(s)” and “DL-RS resource(s)” may be used interchangeably herein. The aforementioned “DL-RS(s)” and “DL-RS resource(s)” may belong to different DL-RS resource sets. “Measurement gap” and “measurement gap pattern” may be used interchangeably in this disclosure. “Measurement gap pattern” may include parameters such as measurement gap duration, measurement gap repetition period, and/or measurement gap periodicity.

An LMF is a non-limiting example of a node or entity (e.g., network node and/or entity) that may be used for or to support positioning and/or sensing. Any other node or entity may be substituted for LMF and still be consistent with this disclosure.

The WTRU may receive a preconfigured threshold(s) from the network (e.g., LMF, gNB). The LOS indicator may be a hard (e.g., 1 or 0) or a soft indicator (e.g., 0, 0.1, 0.2 . . . ,1). The LOS indicator may indicate the likelihood of the presence of an LOS path between TRP and WTRU and/or along DL-RS. The LOS indicator may be associated with a transmission/reception point (TRP) and/or PRS resource ID (e.g., index). The WTRU may receive the LOS indicator from the network per TRP and/or resource ID. Alternatively, the WTRU may determine the LOS indicator per TRP and/or resource ID based on measurements. The non-line of sight (NLOS) indicator may indicate the likelihood of the presence of an NLOS path between TRP and WTRU and/or along DL-RS.

As described herein, “ID” and “index” may be used interchangeably. “Training” and “data collection” may be used interchangeably herein. “Sounding reference signal” (SRS) and “SRS for positioning” (SRSp) may be used interchangeably herein. The “UE-side condition”, “UE condition,” and “UE implementation” may be used interchangeably herein.

A WTRU location may be expressed in terms of altitude, latitude, geographic coordinate, and/or local coordinate. A timestamp may be indicated by absolute time, relative time (e.g., in seconds) compared to a reference time, system frame number (SFN), slot index, frame index, subframe index and/or symbol index. Examples of “absolute time” may be coordinated universal time (UTC) time, global navigation satellite system (GNSS) time, locally defined absolute time (e.g., LTE and/or NR time).

The WTRU may receive configurations for a time window such as duration (e.g., expressed in terms of seconds, number of symbols, number of slots, number of frames, and/or number of subframes), start and/or end time (e.g., expressed in terms of absolute time, system time, relative time with respect to a reference time indicated by the network and/or determined by the WTRU, SNF index, slot index, symbol index, frame index, and/or subframe index). The WTRU may receive more than one configuration of a time window where each configuration is associated with an index. The time window may be initiated with a trigger sent by the network. For example, the WTRU may receive a command (e.g., downlink control information (DCI)) to initiate an indicated time window indicated via the configuration index. The WTRU may determine to initiate the time window after a configured duration after reception of the command (e.g., N symbols, N slots, N frames, and/or N seconds). The WTRU may receive an activation and/or deactivation command (e.g., DCI and/or MAC-CE) to activate and/or deactivate the time window, respectively, from the network.

The WTRU may receive DL-RS and/or UL-RS (e.g., SRS) configurations for positioning purpose from the network (e.g., LMF). The LMF may forward the PRS configuration and/or SRS configurations to the gNB so that the gNB can schedule PRS transmission and/or SRS reception at the TRP, transmission point (TP) and/or reception point (RP).

A DL-RS configuration may contain at least one of the following parameters: number of symbols, transmission power, number of DL-RS resources included in DL-RS resource set, muting pattern for DL-RS (for example, the muting pattern may be expressed via a bitmap), periodicity, type of DL-RS (e.g., periodic, semi-persistent, and/or aperiodic), slot offset for periodic transmission for DL-RS, vertical shift of DL-RS pattern in the frequency domain, time gap during repetition, repetition factor, resource element (RE) offset, comb pattern, comb size, spatial relation (e.g., with respect to other DL-RSs or UL RS such as SRS for positioning purpose), quasi co-location (QCL) information (e.g., QCL target and/or QCL source) for DL-RS, number of TRPs, absolute radio-frequency channel number (ARFCN), subcarrier spacing, expected reference signal time difference (RSTD), uncertainty in expected RSTD, start physical resource block (PRB), bandwidth, BWP ID, number of frequency layers, start/end time for DL-RS transmission, on/off indicator for DL-RS, TRP ID, DL-RS ID, cell ID, global cell ID, and/or applicable time windows. The WTRU may apply a DL-RS configuration under a condition that the current time is within the applicable time window. Herein, “ID” may be used interchangeably with “index”. Examples of DL-RS may include CSI-RS, PTRS, TRS, and SSB.

UL-RS and/or SRS configurations may include at least one of: resource ID, comb offset values, cyclic shift values, start position in the frequency domain, number of UL-RS symbols, shift in the frequency domain for UL-RS, frequency hopping pattern, type of UL-RS (e.g., aperiodic, semi-persistent and/or periodic), sequence ID used to generate UL-RS and/or other IDs used to generate UL-RS sequence, spatial relation information, indicating which reference signal (e.g., DL-RS, UL-RS, CSI-RS, SRS, and/or DM-RS) and/or SSB (e.g., SSB ID and/or cell ID of the SSB) of the UL-RS may relate spatially where the UL-RS and/or DL-RS aligned spatially; QCL information (e.g., a QCL relationship between UL-RS and/or other reference signals and/or SSB); QCL type (e.g., QCL type A, QCL type B, QCL type C, and/or QCL type D); resource set ID; a list of UL-RS resources in the resource set; transmission power related information; pathloss reference information which may contain index for SSB, CSI-RS or DL-RS; periodicity of UL-RS transmission; bandwidth; carrier component ID; and/or spatial information such as spatial direction information of UL-RS transmission (e.g., beam information and/or angles of transmission), spatial direction information of DL RS reception (e.g., beam ID used to receive DL RS, angle of arrival). Herein, “ID” may be used interchangeably with “index”. Examples of UL-RS may include SRS and/or SRS for positioning purposes.

The 3GPP protocol standards specify the following categories of WTRU positioning: A “DL positioning method” may refer to any positioning method that uses downlink reference signals such as PRS. The WTRU may receive multiple reference signals from TP(s). The WTRU may measure DL-RSTD and/or reference signal receive power (RSRP). Examples of DL positioning methods are downlink angle of departure (DL-AoD) and/or downlink time difference of arrival (DL-TDOA) positioning.

A “UL positioning method” may refer to any positioning method that uses uplink reference signals such as SRS for positioning. The WTRU may transmit SRS to multiple RPs. The RPs may measure the uplink relative time of arrival (UL-RTOA) and/or RSRP. Examples of UL positioning methods may be uplink time difference of arrival (UL-TDOA) and/or uplink angle of arrival (UL-AoA) positioning.

A “DL and UL positioning method” may refer to any positioning method that uses both uplink and downlink reference signals for positioning. A WTRU may transmit SRS to multiple TRPs. A gNB may measure reception to transmission (Rx-Tx) time difference which is calculated based on the time of arrival of DL-RS (e.g., PRS). The gNB may measure RSRP for the received SRS. The WTRU may measure Rx-Tx time difference for PRS transmitted from multiple TRPs. The WTRU may measure RSRP for the received PRS. The Rx-TX difference and/or possibly RSRP measured at WTRU and/or gNB may compute round trip time. Herein, “UE Rx-Tx time difference” refers to the difference between arrival time of the reference signal transmitted by the TRP and transmission time of the reference signal transmitted from the WTRU. An example of DL and UL positioning method is multi-RTT positioning.

The WTRU may obtain a channel impulse response (CIR) from the network. The network may indicate DL-RS configuration(s) such as DL-RS resource IDs associated with the CIR. For example, the CIR may be associated with DL-RS resource ID. In this case, the WTRU may determine that the CIR is derived and/or based on the measurements made on the DL-RS resource associated with the ID. Alternatively, the WTRU may determine that the channel along the direction of transmission of the DL-RS or reception of the DL-RS corresponds to the CIR.

The CIR may be associated with a TRP ID. In this case, the WTRU may determine that the CIR represents the channel between the associated TRP and WTRU. The CIR may be associated with more than one TRPs where the network may include TRP indices associated with the CIR. The CIR may be associated with a cell. In this case, the WTRU may receive cell ID and/or index associated with the CIR from the network. The CIR may be associated with more than one TRPs and/or DL-RS resource IDs. In this case, the WTRU may determine that the channel between the TRPs and the WTRU corresponds to the CIR. Alternatively, the WTRU may determine that the channel along the transmission directions of DL-RSs associated with IDs and/or reception directions of the DL-RS correspond to the CIR.

More than one CIR may be associated with one parameter from DL-RS configurations (e.g., TRP ID, DL-RS resource ID, and/or frequency layer ID). For example, the WTRU may receive information related to 2 CIRs associated with a TRP from the network. Alternatively, the WTRU may report information related to more than one CIR associated with DL-RS configuration (e.g., TRP ID and/or DL-RS resource ID) based on the measurements to the network. There may be more than one CIRs associated with DL-RS configuration since the WTRU and/or the network may observe different channel characteristics based on the AoA of DL-RS and/or UL-RS.

CIR may be represented by a delay profile (DP) or a power delay profile (PDP). A PDP may be defined as a set of delays and power profiles, such as [τ_0,τ_1, . . . , τ_(N−1)] and [p_0,p_1, . . . , p_(N−1)], where p_k may correspond to relative power at the k\hat{ }th path compared to the first path. A DP may be defined as a set of delays [τ_0,τ_1, . . . , τ_(N−1)], with respect to a reference timing (e.g., first path and/or indicated reference timing), which may indicate a path delay for each path. Each path may have a path power above a p_threshold. The WTRU may receive the p_threshold from the network to derive delay profile from power delay profile.

The channel impulse response the WTRU reports to the network may be defined by configured number of samples (e.g., N) where the WTRU is configured with granularity of samples (e.g., X seconds apart). The WTRU may report samples whose RSRP is over the configured threshold and/or M highest RSRP among the samples. The WTRU may indicate locations and/or sample index of samples where the WTRU measures M highest RSRP samples. The first sample may be defined as the earliest arriving path (e.g., first path). The WTRU may report timing, phase, and/or power information per sample.

The WTRU may receive an indication from the network on how to generate CIR, PDP, and/or DP based on timing, phase and/or power measurements. The WTRU may send a request to the network to receive an indication on which methodologies to use to generate CIR, PDP, and/or DP based on the measurements the WTRU made. For example, the WTRU may receive a message from the network (e.g., via LPP, RRC, MAC-CE, and/or DCI) indicating the DL-RS resource indices and/or associated measurement type(s) (e.g., RSTD and/or AoA) to generate CIR, PDP, and/or DP. In one example, the WTRU may receive an indication from the network indicating to generate CIR, PDP, and/or DP.

The WTRU may receive a threshold (e.g., power threshold) from the network and a timing range (e.g., 0 μs to 1 μs), timing granularity (e.g., every 0.1 μs in the indicated timing range and/or 100 sample points in the indicated timing range) of CIR, PDP and/or DP. In this case, the WTRU may determine to report power and/or timing (e.g., relative timing compared to a reference timing and/or absolute timing) any samples whose received power is over the threshold. The WTRU may send measurements in a report to the network (e.g., LMF and/or gNB) via a semi-static (e.g., LPP and/or RRC) and/or dynamic message (e.g., UCI and/or UL MAC-CE). Herein, DL-RS (e.g., CSI-RS, DM-RS, and/or TRS) and SSB may be used interchangeably

Non-terrestrial networks (NTN) may facilitate deployment of wireless networks in areas where land-based antennas are impractical, e.g., due to geography and/or cost. It is envisioned that, coupled with terrestrial networks, NTN may enable truly ubiquitous coverage of 5G networks. Initial Rel-17 NTN deployments may support basic talk and/or text anywhere in the world. However, it is expected that further releases coupled with proliferation of next-generation low-orbit satellites will enable enhanced services, e.g., web browsing.

A basic NTN may consist of an aerial or space-borne platform which, via a gateway (GW), transports signals from a land-based based gNB to a WTRU and vice-versa. Current Rel-17 NR NTN may support power class 3 WTRU with omnidirectional antenna and/or linear polarization, and/or a very small aperture antenna (VSAT) terminal with directive antenna and/or circular polarization. Support for LTE-based narrow-band internet of things (NB-IoT) and enhanced machine type communication (eMTC) type devices are also standardized in Rel-17. Regardless of device type, it is assumed all Rel-17 NTN WTRUs are GNSS capable.

Aerial and/or space-borne platforms may be classified in terms of orbit, with Rel-17 standardization focusing on low-earth orbit (LEO) satellites with altitude range of 300-1500 km and geostationary earth orbit (GEO) satellites with altitude at 35,786 km. Other platform classifications such as medium-earth orbit (MEO) satellites with altitude range 7000-25,000 km and high-altitude platform stations (HAPS) with altitude of 8-50 km may be implicitly supported. Satellite platforms may be further classified as having a “transparent” or “regenerative” payload. Transparent satellite payloads implement frequency conversion and/or radio frequency (RF) amplification in both uplink and/or downlink, with multiple transparent satellites possibly connected to one land-based gNB. Regenerative satellite payloads can implement either a full gNB and/or gNB DU onboard the satellite. Regenerative payloads may perform digital processing on the signal including demodulation, decoding, re-encoding, re-modulation and/or filtering.

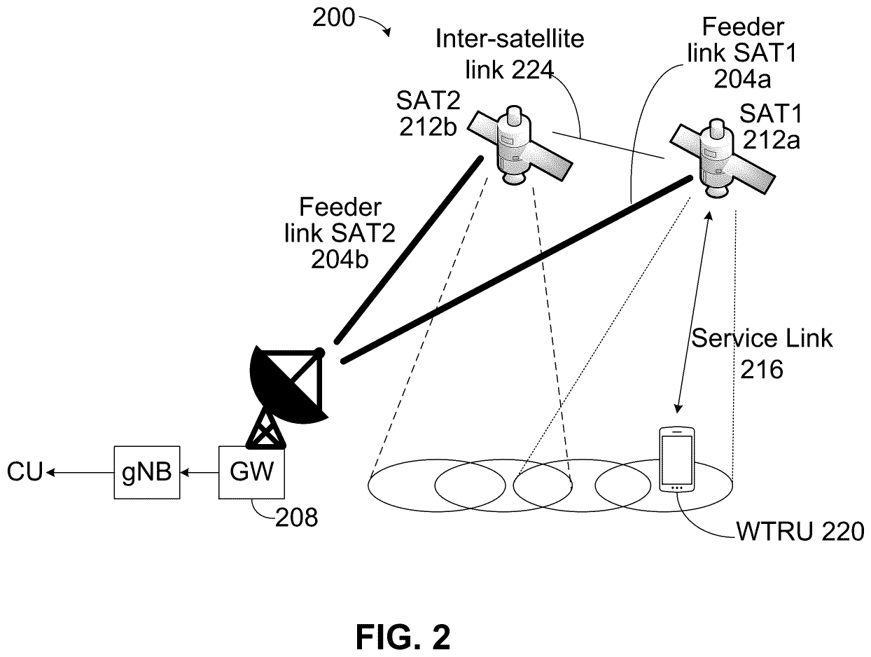

FIG. 2 depicts the different interfaces in a non-terrestrial network (NTN) 200. The following radio interfaces are depicted in FIG. 2: a feeder-link 204a, b may be a wireless link between the GW 208 and satellites 212a, b (e.g., SAT1 and SAT2 as depicted in FIG. 2). The service link 216 may be a radio link between the satellite 212a, b and WTRU 220. The inter-satellite link (ISL) 224 may be a transport link between satellites 212a, b. The ISL may be supported by regenerative payloads. The ISL 224 may be a 3GPP radio or proprietary optical interface.

Depending on the satellite payload configuration, different 3GPP interfaces may be used for each radio link. In a transparent payload, the NR-Uu radio interface may be used for both the service link and/or feeder-link. For a regenerative payload, the NR-Uu interface may be used on the service link, and/or a satellite radio interface (SRI) may be used for the feeder-link. 3GPP has not currently defined ISLs for Rel-17.

An NTN satellite may support multiple cells where each cell consists of one or more satellite beams. Satellite beams may cover a footprint on Earth (like a terrestrial cell). Satellite beams may range in diameter from 100-1000 km in LEO deployments, and/or 200-3500 km diameter in GEO deployments. Beam footprints in GEO deployments may remain fixed relative to Earth. In LEO deployments, the area covered by a beam/cell may change over time due to satellite movement. This beam movement may be classified as “Earth moving” where the LEO beam moves continuously across the Earth. The beam movement may also be classified as “Earth fixed” where the beam is steered to remain covering a fixed location until a new cell overtakes the coverage area in a discrete and/or coordinated change.

Due to the altitude of NTN platforms and/or beam diameter, the round-trip time (RTT) and/or maximum differential delay may be significantly large than that of terrestrial systems. In a typical transparent NTN deployment, RTT may range from 25.77 ms (e.g., LEO at 600 km altitude) to 541.46 ms (GEO) and/or maximum differential delay from 3.12 ms to 10.3 ms. The RTT of a regenerative payload may be approximately half that of a transparent payload, as a transparent configuration consists of both the service and/or feeder links, whereas the RTT of a regenerative payload considers the service link only. To minimize impact to existing NR systems (e.g. to avoid preamble ambiguity or properly time reception windows), prior to initial access, a WTRU may performs timing pre-compensation.

Artificial intelligence may be broadly defined as the behavior exhibited by machines that mimics cognitive functions to sense, reason, adapt, act, and/or providing the ability to discern patterns.

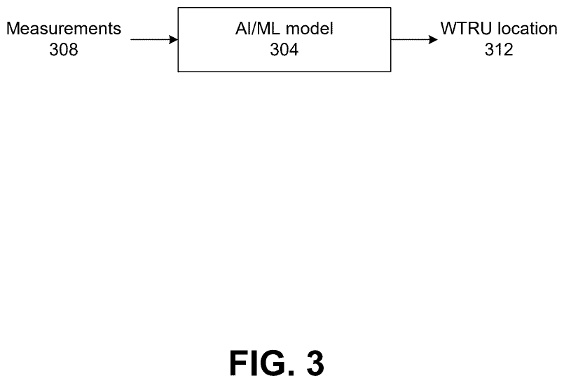

FIG. 3 depicts a diagram of an artificial intelligence or machine learning (AI/ML) model to estimate and/or obtain wireless transmit/receive unit (WTRU) location. As shown in FIG. 3, the WTRU may input the AI/ML model 304 with measurements 308 including but not limited to: timing, phase, and/or power measurements such as RSTD, time of flight, time of arrival (ToA), time of departure (ToD), carrier phase measurement, carrier phase difference measurement, RSRP, RSRP per path, and/or processed (e.g., averaged) measurements. The WTRU may obtain the WTRU location 312 from the AI/ML model. The output of the AI/ML model may be referred to as “inference” herein.

As an input to the AI/ML model, if the AI/ML model may be associated with and/or trained with measurements from more than one TRPs, then the UE may use measurements made from more than one TRPs. If the AI/ML model is trained with measurements from more than one TRPs, the WTRU may receive an indication or configuration from the network about identification information about the TRPs (e.g., TRP IDs and/or PRS IDs) that the AI/ML model is trained with. In the examples described here in, “AIML” and “AI/ML” may be used interchangeably.

Examples of inputs for an AI/ML model for positioning may be at least one or combination of the following: RSRP of PRS resource(s); statistical measure of RSRP (e.g., mean, variance etc.) per PRS resource(s); maximum and/or minimum value of RSRP per PRS resource(s); RSRP of PRS resource(s) per path; RSRP of PRS resource(s) per antenna port; received signal code power (RSCP) of PRS resource(s) per path; RSCP of PRS resource(s) per antenna port; RSTD and/or reference signal carrier phase difference (RSCPD) of PRS resource(s); statistical measure of RSTD per PRS resource(s); maximum and/or minimum value of RSTD per PRS resource(s); RSTD and/or RSCPD of PRS resource(s) per path; RSTD and/or RSCPD of PRS resource(s) per antenna port; Time of arrival per PRS resource(s); time of arrival per PRS resource(s) per path; time of arrival per PRS resource(s) per port; statistical measure of Time of arrival per PRS resource(s); maximum and/or minimum value of time of arrival per PRS resource(s); CIR estimated based on DL-RS(s) (e.g., PRS, CSI-RS, and/or DM-RS) where CIR may be associated with a TRP and/or TRPs; PDP estimated based on DL-RS(s) (e.g., PRS, CSI-RS, and/or DM-RS) where CIR may be associated with a TRP and/or TRPs; DP (delay profile) estimated based on DL-RS(s) (e.g., PRS, CSI-RS, and/or DM-RS) where CIR may be associated with a TRP and/or TRPs.

In 3GPP, the WTRU's AI/ML model may output the WTRU location. The WTRU may need to train AI/ML models with ground truths and/or associated measurements. The WTRU may need to maintain consistent conditions for measurements between data collection and/or inference phase.

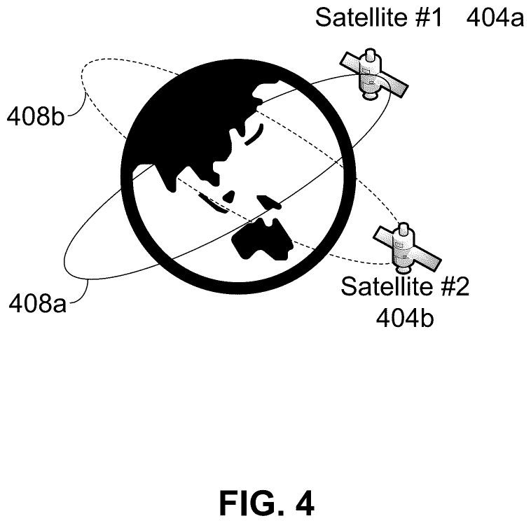

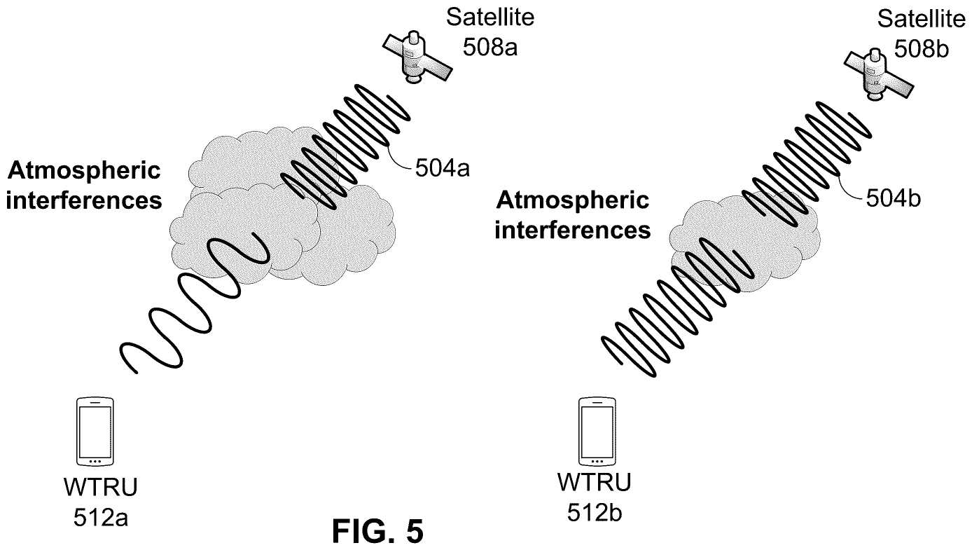

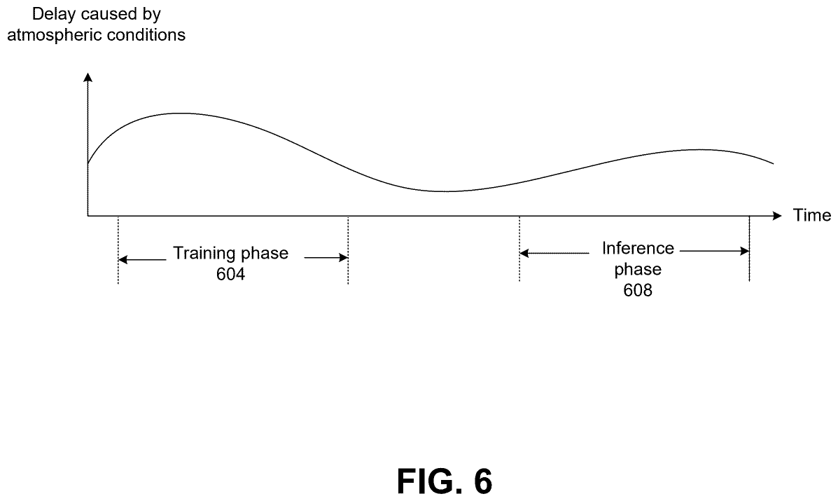

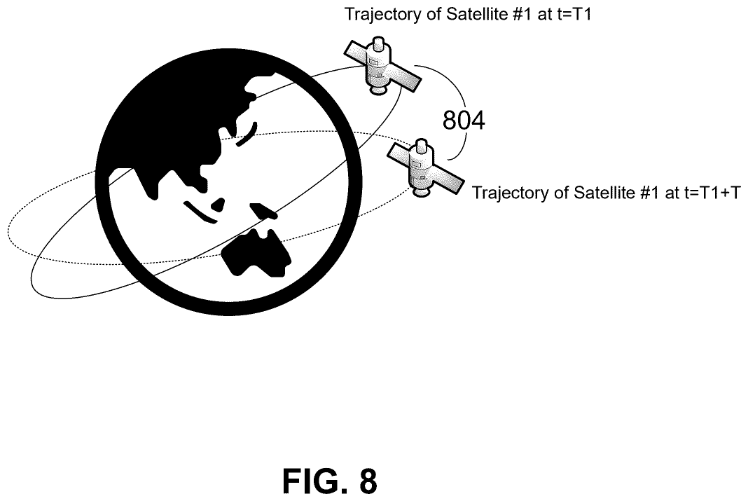

Network (NW) conditions (e.g., satellite positions) and/or environment e.g., atmospheric condition illustrated in FIG. 5 and/or locations of satellite positions depicted in FIG. 4, conditions may be time-varying, e.g., as depicted in FIG. 6. In addition, due to time varying environment, the associate ID configured by the network may become outdated. As depicted in FIG. 8, the trajectory of a satellite may change over time. The WTRU may determine consistency across data collection phase and/or inference phase. The WTRU may determine whether the configured associated ID is valid.

The WTRU may determine consistency in network-side conditions and/or environment conditions based on the associated ID. The WTRU may verify the configured associated ID by checking validity condition(s). If a validity condition is not satisfied, the WTRU may requests for an associated ID. If the associated ID is time varying, the WTRU may determine consistency by comparing the associated ID between training and/or inference phases.

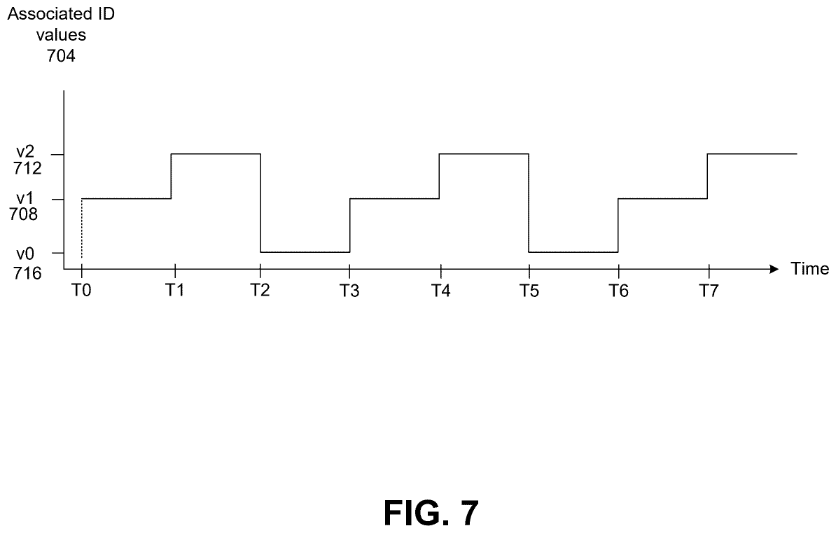

The WTRU may perform the following steps: the WTRU may receive DL-RS configurations. The WTRU may send a request to the network for an associated ID. The WTRU may receive from the network an associated ID(s) with a time varying characteristics as depicted in FIG. 7. The WTRU may receive a parameter (e.g., TRP location, atmospheric condition, weather, power sharing, and/or network energy saving (NES) status at the satellite) that the ID is associated. The WTRU may determine the start and/or end times of the time-varying characteristics (e.g., when to start tracking associated IDs and/or where to compare the associated IDs). The WTRU may receive validation conditions (e.g., validity area) for the associated ID (e.g., associated ID for a zone in a cell). An associated ID may be associated with LMF, wherein the WTRU may need to differentiate associated IDs.

If a condition is satisfied, the WTRU may request for reconfiguration of an associated ID where a condition may be at least one of the following: difference between inferences (e.g., WTRU location) with the same associated ID and/or measurements made from the same of DL-RSs is above a configured threshold. The WTRU may move out of the validity area associated with the associated ID. The WTRU may receive a request from the network to generate inference under the same associated ID and indicated set of DL-RSs. The WTRU may be a positioning reference unit (PRU) whose location is known by the network (e.g., LMF). The WTRU may determine consistency based on the characteristics of time-varying associated ID as depicted in FIG. 7 and/or report location information determined by the AI/ML model(s). The WTRU may report associated ID(s) used for data collection and/or inference generation. Alternatively, the WTRU may report satellite ephemeris.

The WTRU may determine consistency in network-side conditions and/or environment conditions based on the associated ID. The WTRU may verify the configured associated ID by checking validity condition(s). If a validity condition is not satisfied, the WTRU may requests for an associated ID. If the associated ID is time varying, the WTRU may determine consistency by comparing the associated ID between training and/or inference phase.

The training phase and/or inference phase may be indicated by the network (e.g., LMF), explicitly and/or determined by the WTRU implicitly. The training phase may be defined by the duration during which the WTRU and/or training entity receives PRS and/or trains an AI/ML model with measurements and/or an associated ground truth. The training phase may be terminated by the network or by the request (e.g., indicating that training is complete, and/or the WTRU received trained AI/ML models) from the WTRU or training entity. The inference phase may be defined by the duration where the WTRU uses the trained AI/ML model(s) to generate inference. The inference phase may start when the WTRU receives, from the network, a request for reference (e.g., WTRU location). The inference phase may start when the WTRU requests, from the network, for location information, transmission of PRS, assistance information, and/or PRS configuration.

The training phase and/or inference phase may overlap in time. For example, the over-the-top (OTT) server and/or WTRU may be training AI/ML models as the WTRU generates inference as per request from the network.

The WTRU may receive from the AI/ML model training entity, the parameters for the trained AI/ML model (e.g., weights) and/or meta data for the AI/ML model. The meta data may contain PRS configurations, assistance information, and/or association information used during the training phase.

An AI/ML model training entity (e.g., WTRU, OTT, and/or NW) may need to train an AI/ML model using measurements or data (e.g., CIR) derived from the measurements. Training an AI/ML model may require measurements.

As described herein, “training” and “data collection” may be used interchangeably. During the training phase, the entity may collect measurements based on the received DL RS and/or from other entities (e.g., WTRU, OTT, and/or NW). Using the collected measurements, the entity may train an AI/ML model. A WTRU may obtain the trained AI/ML model from the entity.

Assistance information related to network implementations provided by the network is important for the AI/ML model training entity (e.g., WTRU, OTT, and/or NW) as this information indicates the AI/ML's training conditions. For example, the conditions may include at least one of the following: TRP location; angle in antenna and/or antenna panels at TRPs; location of antenna and/or antenna panels at TRPs; synchronization error among gNBs and/or TRPs; beam shape; beam width; boresight direction of a beam; characteristics of hardware and/or software at the network, such as characteristics of an amplifier used for transmission and/or number of antenna elements at Tx and/or Rx, number of panels, etc. ; timing, power and/or phase offset in signals transmitted by a TRP.

The WTRU may indicate WTRU's capability to the network. The WTRU may report one or more of the following capabilities: achievable accuracy for an area; for example, the WTRU may indicate achievable level accuracy for an area (e.g., less than 0.5 meters for a cell) for a functionality or AI/ML model. Capable complexity (memory size, computation time, processing time); for example, the WTRU may indicate how long it may take to generate an inference for a functionality or AI/ML model. AI/ML model input type (e.g., CIR, PDP, and/or DP) that the WTRU can accept and/or generate. For example, the WTRU may indicate the inputs for an AI/ML model the WTRU is capable of supporting. Capable input complexity (e.g., number of samples/paths pre-CIR, PDP, and/or DP). For example, the WTRU may indicate the supportable number of inputs (e.g., number of TRSs and/or PRS resources) to make measurements on. The WTRU may indicate the number of samples and/or paths per CIR, PDP or DP the WTRU can make measurements on. The number of cells (e.g., satellite cells and/or terrestrial cells), TRPs (e.g., satellites), zones, and/or areas the WTRU may collect measurements from (e.g., a zone may be defined with respect to a reference point and/or zone may be expressed in terms of distance or area with respect to the reference point). The number of BWPs, bandwidth, and/or frequency layers the WTRU can measure. Measurement type (e.g., power, timing, and/or phase) that the WTRU can measure. Periodicity and/or frequency of inference generation and/or reporting generation (e.g., periodicity may be expressed in terms of slots, symbols, frames, subframes, and/or time unit, such as seconds). Duration for generating inference (e.g., expressed in seconds and/or minutes); RRC state (e.g., RRC_CONNECTED, INACTIVE, and/or IDLE); whether the WTRU is mobile and/or stationary; whether the WTRU can make measurements on the DL-RSs transmitted by satellites; whether the WTRU is capable of training AI/ML model(s) and/or generating inference using an AI/ML model(s).

The WTRU may receive, from the network (e.g., LMF and/or gNB) a request for AI/ML based positioning method. The WTRU may send a reply for the request. The WTRU may accept and/or reject the request based on the WTRU capability or whether the WTRU has trained AI/ML model(s). The WTRU may receive accuracy requirements from the network. The WTRU may accept and/or reject the accuracy requirement based on WTRU capability or status of AI/ML model(s) (e.g., how much training the AI/ML models have received, whether the WTRU has trained AI/ML model(s)).

The WTRU may receive an explicit associated ID in the DL-RS (e.g., PRS) configuration. For example, an associated ID may be associate with a PRS configuration parameter (e.g., frequency layer ID, TRP ID, PRS ID, and/or PRS resource ID) and/or assistance information (e.g., area ID, PRS boresight direction). TRP IDs may correspond to, or be equivalent to, identification information of satellite(s) (e.g., satellite ID).

The WTRU may receive, from the network, the associated ID via dedicated message (e.g., LPP, RRC) and/or broadcast message (e.g., SIB). The WTRU may send a request for associated IDs. The request may contain at least one or more of the following: desired validity conditions for associated IDs (e.g., desired duration for validity of associated IDs (e.g., 2 days) and/or desired validity area for associated IDs); desired satellites and/or indicated via satellite IDs, the associated IDs should be associated; desired time for provision of associated IDs (e.g., expressed in absolute time, and/or relative time with respect to a reference time); and/or desired environmental parameters (e.g., weather conditions, and/or conditions of stratosphere), the associate IDs should be associated with desired number of associated IDs'desired time characteristics of associated IDs (e.g., static and/or time variant). An associated ID may represent network side conditions (e.g., satellite ephemeris, satellite trajectory information, conditions, and/or locations of satellites). An associated ID may represent environmental conditions (e.g., atmospheric conditions). An associated ID may represent both network side conditions and/or atmospheric conditions.

The WTRU may receive an associated ID from the network at a configured timing. The timing may be defined at a timing offset from an event (e.g., initiation of satellite communication, initiation of data collection, inference phase, satellite based positioning, and/or AI/ML assisted satellite based positioning). The WTRU may receive details of the timing from the network. For example, the timing may be expressed in terms of absolute time, relative time, and/or system time (e.g., SFN, slot index, frame index, subframe index, and/or symbol index).

An associated ID may represent the ephemeris of a satellite(s). If the associated ID for a satellite (e.g., mobile TRP and/or TRP) is the same during the training and inference phase, the WTRU may determine that the ephemeris of the satellite is also similar or the same. An example of the ephemeris of satellites are shown in FIG. 4. In the illustrated example, satellite #1 404a and satellite #2 404b may have different trajectories 408a, b (e.g., ephemeris). The WTRU may receive an associated ID corresponding to each satellite (e.g., satellite #1 404a and satellite #2 404b). In another example, the WTRU may receive an associated ID corresponding to more than one satellites (e.g., one associated ID for satellite #1 404a and satellite #2 404b).

An associated ID may be associated with a satellite(s), satellite beam(s), satellite cell(s), and/or NTN cell(s). The WTRU may receive, from the network, identification information of the parameter (e.g., satellite cell ID and/or satellite beam ID) that the associated ID is associated.

An associated ID may be associated with more than one satellites. For example, the WTRU may receive an indication from the network identification information of a satellite (e.g., TRP ID and/or satellite ID). The WTRU may receive an association information between the associated ID and a group of satellites using identification information for satellites. Based on a configured positioning method, the WTRU may determine that an associated ID is associated with one or more satellites. If an RTT based positioning method is configured, the WTRU may determine that an associated ID is associated with a satellite. If the WTRU is configured with the DL-TDOA positioning method, the WTRU may determine that the associated ID is associated with more than one satellites (e.g., 4 satellites).

In some NTN deployment scenarios, satellites with many beams (e.g., 1200) may require power to be split among different beams and/or turned off entirely due to onboard power limitations. This results in lower equivalent isotropic radiated power (EIRP) density per beam and/or worse DL coverage than originally expected. To ensure that sufficient coverage is available to area(s) serving most users, the satellite may dynamically allocate power between satellite beams (e.g., as the satellite is moving overhead). Such dynamic changes in satellite coverage may impact, for example, the applicability of a satellite model and/or the consistency of collected data.

The WTRU may receive an associated ID for conditions at a satellite. For example, an associated ID may indicate power saving schemes implemented at the satellite. The satellite may use a transmission scheme (e.g., power sharing scheme) and/or energy and/or power saving schemes that may change the satellite coverage. The power and/or energy sharing schemes may change RSRP of the received DL-RS at the WTRU. The WTRU may receive the associated ID in the configuration.

Upon determining that a WTRU may be impacted by a future power sharing decision, the WTRU may re-acquire and/or update the associated ID (e.g., for the purposes of data collection and/or model applicability determination). Considering the deterministic nature of satellite movement, such power sharing decisions may be notified in advance (e.g., in order to allow sufficient preparation time to maintain coverage and/or to consider the impact of satellite power sharing on AI/ML data collection/model performance). Examples of information to support WTRU awareness of network power sharing may include, one or more of the following: the power sharing state of a specific area of coverage, which can represent the power and/or portion of power allocated to the beam/cell serving the area. The specific area (e.g., satellite coverage footprint or a subsection of the satellite coverage) associated with the power sharing state. The time of satellite power sharing, e.g., the time a power sharing state is starting. This time may be in the past, current value, or future time; the time the power sharing state is ending; a time duration the power sharing state is applicable; and/or the duration of a power sharing state. Power sharing assistance information (e.g., power sharing state, timing information, and/or impacted area etc.) about one or more neighboring areas associated ID to represent the power saving state of the satellite

The WTRU may estimate that it will be impacted by a power sharing decision. The estimation may be based on, for example, the power sharing assistance information and/or one or more other characteristics of the satellite such as: assistance information to determine the trajectory of the satellite/cell like the satellite ephemeris data (e.g., the satellite location, direction, speed, or orbital information); cell and/or beam reference point; assistance information to determine the trajectory of the satellite reference point (e.g., if the satellite deployment uses Earth-moving beams); satellite footprint information (e.g., the satellite footprint diameter, cell footprint diameter, and/or beam footprint diameter); the beam configuration for a cell and/or satellite (e.g., the total number of beams on a satellite, the number of beams within a cell, the pattern of beams within a cell, the polarization characteristics of a beam); and/or power characteristics of a satellite (e.g., the EIRP density per beam, the total power available to a satellite etc.)

Similar information (e.g., power sharing assistance information and/or one or more of the above) may also be provided for a neighboring satellite, cell, beam, and/or upcoming satellite, cell, and/or beam, which the WTRU may use to estimate the impact of a future power sharing decision. The WTRU may also use one or more WTRU characteristics to evaluate the coverage state. For example, the WTRU may use on or more of the following: the WTRU location information (e.g., GNSS position); information about the WTRU movement (e.g., WTRU speed and/or direction); WTRU receiver characteristics (e.g., antenna characteristics like number of antennas, beamforming capability, whether the antenna is omnidirectional, and/or directive etc.); WTRU power characteristics (e.g., WTRU power class)

The WTRU may use one or more pieces of assistance information (e.g., power sharing assistance information and/or other information described above) to determine whether the WTRU will be impacted by a power sharing decision and the corresponding impact to associated ID.

The WTRU may determine whether it is currently located in an area impacted by power sharing using the power sharing assistance information. For example, the WTRU may acquire the power sharing assistance information indicating the power sharing state of different areas of the cell. The WTRU may then acquire its own location information and/or determine if it is located within an area of cell coverage experiencing reduced coverage due to power sharing. The WTRU may determine it is within an area undergoing power sharing, e.g., via one or more of the following methods: the WTRU may be served by a beam, cell, and/pr satellite which is described as undergoing power sharing; the WTRU is located within an area described within the power sharing assistance information (e.g., the WTRU distance between a reference point is less than the described radius, the WTRU is located within a range of longitude/latitude, and/or the WTRU is located within an explicitly described polygonal area, etc.)

The WTRU may determine whether it will be in an area which will be impacted by a future power sharing decision. For example, the WTRU may acquire the power sharing assistance information indicating the power sharing state of different areas within the cell. The assistance information may further indicate the associated timing of the power sharing state (e.g., when the power sharing state will be activated and/or for how long the power sharing state will occur). The WTRU may acquire its location information and/or determine if it is located within an area impact by a future power sharing decision. The WTRU may determine the characteristics of when it will be impacted by the power sharing decision (e.g., the start time and/or duration of impact).

In case the satellite is non-geosynchronous (e.g., LEO and/or mid-Earth orbit (MEO)), the WTRU may also factor in satellite movement when determining whether the WTRU will be impacted by a future power sharing decision. For example, in addition to acquiring the power sharing assistance information, the WTRU may acquire additional information (e.g., via SIB reception) to determine the trajectory of the cell such as the satellite ephemeris data, cell footprint information, and/or one or more cell reference point(s). The WTRU may acquire its own location and, via the trajectory information, determine the series of upcoming cell(s) and/or area(s) which will serve the WTRU location in the future. The WTRU may then determine if these upcoming areas are associated with a future power sharing decision. The WTRU may determine the duration of impact factoring in both the duration the WTRU will be within the coverage area and the duration of the power sharing decision.

The WTRU may assess the impact of neighboring power sharing decisions in a similar manner as described herein, albeit via acquisition of the power sharing assistance information for neighboring cells, beams, and/or satellites. The network may indicate that a power sharing decision may affect one or more WTRUs. The network may send a dedicated message (e.g., via RRC and/or MAC CE) information to as to whether the WTRU will be impacted by a power sharing decision. This message may include additional assistance information such as power sharing state information and/or timing of power sharing decision. Such information may also be group cast to a set of WTRUs, which the WTRU may monitor for via a dedicated group RNTI.

Upon the determination of when and/or to what degree a WTRU may be impacted by a future network power sharing decision, the WTRU may update the associated ID (e.g., at the time and/or duration of the network power sharing decision). The WTRU may re-acquire the associated ID from the network (e.g., upon the start of network power sharing). The WTRU may receive configurations related to NES for satellites. For example, each NES state and/or status may be associated with a transmission characteristic (e.g., the number of antennas, antenna elements activated, and/or reduced transmission power). An associated ID may be associated with a NES state and/or status and the WTRU may determine the associated ID based on the configured NES state and/or status.

An associated ID may represent the weather (e.g., raining, sunny, and/or cloudy) condition in the area the WTRU is located. The WTRU may receive, from the network (e.g., LMF and/or gNB) the associated ID in the configuration. The WTRU may determine that the weather condition is the same between training and/or inference phase if the corresponding associated IDs are the same.

FIG. 5 depicts diagrams of atmospheric interfered conditions on satellites. An associated ID 504a, b may represent the condition of atmosphere (e.g., stratosphere, troposphere) between a satellite 508a, b and the WTRU 512a, b. The atmospheric conditions between the satellite 508a, b and the WTRU 512a, b may affect measurements (e.g., power, time measurement, phase) of the DL-RS received at the WTRU. An example is depicted in FIG. 5 where phase of the received signal changes based on the atmospheric conditions between the satellite 508a, b and the WTRU 512a, b. The WTRU 512a, b may receive, from the network, the associated ID 504a, b in the configuration (not pictured in FIG. 5). The WTRU may determine that the atmospheric condition is the same between training and inference phase if the corresponding associated IDs are the same.

The WTRU may receive a request to make measurements on the configured DL-RSs transmitted from terrestrial networks (e.g., TRP) and/or non-terrestrial networks (e.g., satellites). The WTRU may receive indications on which DL-RSs (e.g., via DL-RS resource ID) to make measurements. The WTRU may receive a request to report measurements. The WTRU may receive a request, to the network, to report the WTRU location determined based on the measurements made from DL-RSs transmitted from terrestrial network and/or non-terrestrial network.

The network may not determine the associated ID which may include atmospheric conditions. In such a case, the network may need to ask the WTRU for assistance. The WTRU may receive a request from the network to report measurements and/or assistance information (e.g., WTRU condition and/or WTRU location). The network may use the reported measurements to generate an associated ID. The WTRU may make measurements on the DL-RS received from the network. The WTRU may report measurement to the network. The WTRU may report assistance information (e.g., WTRU location obtained from GNSS and/or radio access technology (RAT) dependent positioning methods) and/or information obtained from RAT independent sources (e.g., sensors, local weather conditions, measurements made on GNSS, and/or assistance information obtained from non-3GPP systems such as GNSS systems). The WTRU may receive a request from the network to report WTRU-side conditions (e.g., whether the WTRU is in power saving mode, how many antennas are activated for reception or transmission, and/or whether the WTRU is mobile or stationary).

The WTRU may send a request to the network for an associated ID in the request for assistance information (e.g., satellite ephemeris). The WTRU may determine to send a request for the associated ID when the data collection and/or training phase is initiated by the network or WTRU. The WTRU may determine to send a request for associated IDs if the WTRU is not configured with associated IDs.

An associated ID may be a temporary ID. The associated ID may have a validity area. The associated ID may be valid within an area (e.g., cell(s), zone(s), satellite beam(s), coverage of a satellite, and/or satellite cell(s)) but the associated ID may not be globally unique. The same associated ID may be issued by the network in different cells. Thus, the WTRU may determine validity condition(s) for the associated ID from assistance information provided by the network. If an associated ID is valid within an area (e.g., consisting of a satellite cell(s) and/or terrestrial cell(s)), the WTRU may determine that the associated is invalid when the WTRU moves out of the area. An area may be defined by more than one cell IDs, global cell IDs, and/or PLMN IDs.

The associated ID may be associated with the LMF. If the LMF changes, the WTRU may determine that the associated ID also changes. For example, the WTRU may determine that based on geographical location (e.g., Europe, North America, and/or Asia) that the LMF is updated. The WTRU may receive an associated ID from the network when the LMF changes. The WTRU may send a request for an associate ID if the WTRU determines that the LMF changed.

The associated ID may have time validity. The WTRU may start a timer when the WTRU is configured with the associated ID. Once the time reaches expiration time, the WTRU may determine that the associated ID is not valid. The associated ID may be associated with a validity time window indicated by start and/or end time or duration. The WTRU may determine that the associate ID is invalid outside of the window. If the associated ID not valid, the WTRU may determine that the corresponding PRS configuration does not have an associated ID. As used herein, the terms “PRS configuration” and “assistance information” may be used interchangeably.

Environmental conditions between the satellite and the WTRU may change over time. Conditions at the satellite may change over time. An associate ID may be a function of time to represent time varying environment(s). FIG. 6 depicts different channel conditions between data collection and inference phases. An example of time varying conditions is depicted in FIG. 6. In the illustrated example, delay caused by time varying atmospheric condition changes over time. Therefore, the WTRU may experience different perturbation (e.g., time delay) between the training phase 604 and the inference phase 608.

The WTRU may receive an associated ID which changes over time. The time varying characteristics for the associated ID may be represented by at least one or combination of the following elements: the WTRU may be configured with a time window during which the associated ID changes. The configuration details for the time window may include start and/or end time or duration.

The WTRU may be configured with a function (e.g., step function and/or sinusoidal function) that describes the time varying characteristics of the associated ID. For example, the WTRU may determine, from the function, that the value of the associated ID is 1 between Tref and Tref+T, where Tref is the reference time and T is time duration expressed in, e.g., seconds. In the same example, the WTRU may determine from the configuration that the associated ID is 0 between Tref+T and Tref+2T. The WTRU may receive, from the network, parameters for the function (e.g., periodicity of the function, duration of the function, initial value of the function, and/or parameters such as coefficients of polynomials for the function). The WTRU may receive an initial value of the function to determine the associated value during data collection and/or inference phase.

An example of a time varying associated ID is shown in FIG. 7. In the example, the values of the associated ID 704 changes based on time. For example, between t=T0 and t=T1, the associated ID is v1 708. Between t=T1 and t=T2, the associated ID is v2 712. Between t=T2 and t=T3, the value of the associated ID is v0 716. The WTRU may be configured with an associated ID function. The associated ID function may be a function of time (e.g., step function and/or sinusoidal function) where an example is shown in FIG. 7. The WTRU may receive, from the network, parameters for the function (e.g., periodicity of the function, duration of the function, and/or initial value of the function, parameters such as coefficients of polynomials for the function). The WTRU may receive an initial value of the function to determine the associated value during data collection (e.g., first time period) and/or inference phase (e.g., second time period).

The WTRU may determine whether the associated ID is static and/or time variant via assistance information sent by the network. The WTRU may determine that the if the associated ID is time variant, the WTRU may request for an associated ID value when the WTRU needs to determine consistency between training and/or inference mode.

The WTRU may receive the first associated ID from the network prior to or during the data collection phase. The WTRU may receive information from the network that the received associated ID is time variant. During the inference phase, the WTRU may determine to send a request to the network for a second associated ID so the WTRU can check whether consistency is maintained during the data collection phase and inference phase. If the first and second associated IDs are the same, the WTRU may determine that measurements made during the data collection phase and inference phase are consistent.

The WTRU may receive the first associated ID from the network prior to or during the data collection phase. The WTRU may receive information from the network that the first associated ID is static. The WTRU may receive the duration for the period the first associated ID remains static. If the data collection phase and inference phase are contained during the duration and/or a time window, the WTRU may determine that the measurements made during the data collection phase and inference phase are consistent. If the data collection phase and inference phase are not contained during the duration, the WTRU may determine to request to the network for a new associated ID, e.g., second associated ID.

As the associated ID may be associated with time varying conditions and/or parameters (e.g., ephemeris of a satellite), the WTRU may need to monitor validity of the configured associated ID. The ephemeris of a satellite may become inaccurate over several years. FIG. 8 depicts is a diagram depicting the trajectory of a satellite over time. In FIG. 8, the trajectory of the satellite 804 may gradually change over time period of T. Thus, the network and/or satellite may need to apply corrections to the ephemeris periodically. Thus the validity of the associated ID may depend on its validity time or area.

The WTRU may receive configurations for monitoring the configured associated ID. The WTRU may receive periodicity for monitoring and/or verifying the associated ID. The WTRU may receive a request from the network to monitor and/or verify the associated ID. Based on the monitoring periodicity, the WTRU may perform the configured procedure (e.g., determine a metric).

The WTRU may send a request to configure an associated ID if at least one or combination of the following conditions is satisfied: the WTRU may send a request for an associated ID to the network if a validity condition for the associated ID is not satisfied. For example, if the timer for the associated ID reaches the time limit, the WTRU may determine that the associated ID is not valid anymore. The WTRU may then send a request for a new associated ID from the network.

The WTRU may send a request for an associated ID to the network if an area condition for the associated ID is not satisfied. For example, the WTRU may determine its location based on its location estimate obtained using RAT independent positioning methods (e.g., GNSS) and/or RAT dependent positioning method (e.g., DL-TDOA) using satellite and/or terrestrial DL-RS. The WTRU may determine its location based on the cell ID, global cell ID, and/or area ID, etc. Based on the location estimate, the WTRU may determine if the WTRU is inside and/or outside of the validity area. If the WTRU determines that the WTRU is outside of the validity area, the WTRU may send a request for an associated ID.

The WTRU may receive configurations for a rate of change for environmental parameters (e.g., Doppler drift rate, rate of change in power, timing measurement, and/or phase) or parameters related to the satellites (e.g., speed and/or uncertainty in locations) from which the WTRU receives DL-RS. Based on the configured parameter, the WTRU may determine timing at which the WTRU may sends a request to the network for configuration of an associated ID. For example, the WTRU may receive a rate of change in the ephemeris from the network (e.g., LMF and/or gNB). Based on the rate of change, the WTRU may determine when the change in the ephemeris, compared to the ephemeris when it was initially configured, exceeds the configured threshold.

The WTRU may send measurements or information to the network to indicate to the network that validity condition(s) are broken. The WTRU may send a measurement report (e.g., positioning measurements) to the network to indicate that the area validity condition is not satisfied. The WTRU may indicate the cause of the request for configuration of a new associated ID. The cause may indicate the validity condition(s) that are not satisfied (e.g., area validity is not satisfied, expiration time has reached). The associated function may be associated with validity conditions (e.g., time validity and/or area validity). The WTRU may determine that the associated ID function is invalid if its validity condition is not satisfied (e.g., The WTRU is outside of the validity area, the timer for the associated ID function expired and/or reached the expiration time). If the WTRU determines the associated ID function is invalid, the WTRU may determine to send a request to the network for configuration of an associated ID function. As described herein, “associated ID” and “associated ID function” may be used interchangeably.

The WTRU may receive a response from the network for the request. The WTRU may receive a new associated ID and/or associated information (e.g., time varying characteristics, descriptions of time varying function) from the network. The WTRU may receive a response informing the WTRU to use the configured associated ID before the WTRU sent the request.

The WTRU may receive a new associated ID from the network during the data collection and/or training phase. The WTRU may be configured to restart the data collection phase if the associated ID is updated (e.g., receives a new associated ID from the network) during the data collection phase. By restarting the data collection phase, the WTRU may send a request, to the network, for preferred DL-RS (e.g., PRS) configurations. The WTRU may send an indication to the network that AIML model(s) are trained using the new associated ID. The WTRU may send an indication to the network that the AIMIL model(s) is associated with the new associated ID.

If the WTRU receives a new associated ID from the network during or prior to the inference phase, the WTRU may determine to send a request to the network to initiate the data collection phase. The WTRU may determine to compare the new associated ID and/or associated ID used during the data collection and compare the associated ID values to determine consistency.

The WTRU or network may need to check periodically whether under the configured associated ID, the WTRU may generate consistent inference using the trained AI/ML model. Otherwise, the network may need to adjust network configurations and/or implementations such that under the same associated ID, the WTRU may generate similar inference with the same associated ID and same set of measurements.

The WTRU may be a PRU whose location is known by the network (e.g., LMF and/or gNB). For example, the WTRU, which is a PRU, may receive a request from the network to verify the associated ID. The WTRU may receive, from the network, an indication of a set of DL-RSs (e.g., PRSs), TRPs and/or satellites to make measurements. The WTRU may receive a request to generate inference (e.g., obtain an output from the trained AI/ML model(s)) at two indicated timing occasions with the same associated ID. The WTRU may receive a request from the network to use the same input for the trained AI/ML model (e.g., measurements from the same set of DL-RSs) at the indicated timing occasions. If the difference in the inference at the two timing occasions is greater than the configured threshold, the WTRU may send a report to the network where the report contains the difference in inference, and/or measurements used to generate inference. The WTRU may send a report to the network indicating that verification test failed.

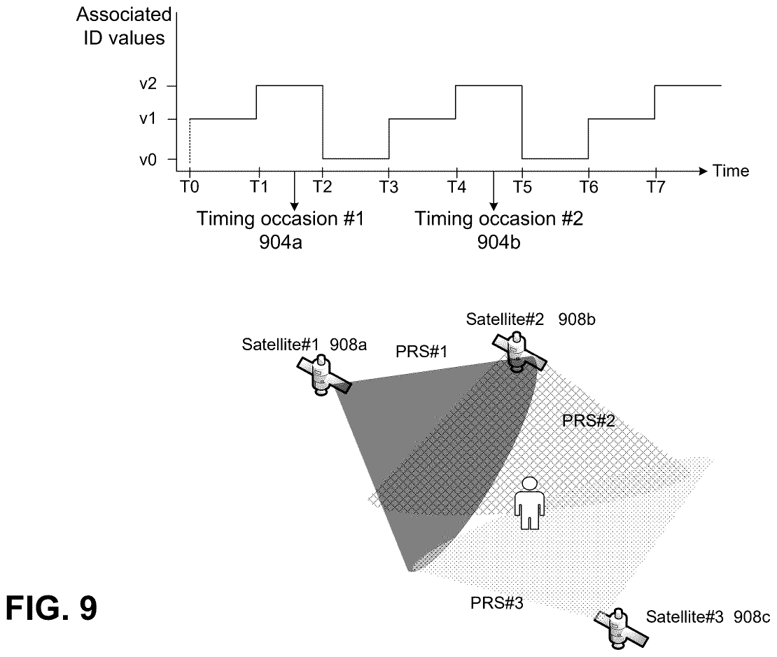

FIG. 9 depicts timing occasions and measurements to make to verify an associated ID. An example is depicted in FIG. 9 where the WTRU receives configurations for timing occasions (e.g., timing occasion #1 904a and timing occasion #2 904b) from the network. The WTRU also receives a request from the network to make measurements on the DL-RSs received from satellite #1 908a, #2 908b and #3 908c.

The WTRU may receive a request from the network to report its location. The WTRU may determine its location based on RAT independent positioning method (e.g., GNSS) and/or RAT dependent positioning method (e.g., DL-TDOA and/or DL-AoD). The WTRU may report its location at different time occasions. The WTRU may receive a request to generate inference using the measurements on the indicated DL-RSs, satellites and/or TRPs. The WTRU may also receive a request to reports its location and generated inference to the network. The WTRU may receive a request from the network to report WTRU type (e.g., PRU or non-PRU). After the WTRU reports the WTRU type, the WTRU may receive a request to verify the associated ID and/or check validity of the associated ID.

The WTRU may perform life cycle management (LCM) to check validity of an associated ID. The WTRU may send a request for the ground truth to the network. The WTRU may request for a set of measurements and/or transmissions of DL-RSs to make measurements for the LCM purpose. Using the same associated ID the AI/ML model(s) are trained with, the WTRU may determine inference of the AI/ML model based on the measurements provided by the network or measurements made by the WTRU on the received DL-RS. The WTRU may determine a difference between the ground truth and inference. If the difference between the ground truth and inference is above the configured threshold, the WTRU may determine to request for a new associated ID.

The WTRU may determine to request for retraining of AI/ML model(s) at the WTRU. The WTRU may request for transmission of indicated DL-RSs (e.g., PRS). The WTRU may send a request for termination of AI/ML based positioning. The WTRU may determine to switch to the configured fallback positioning method (e.g., GNSS based positioning and/or RAT dependent positioning).

The WTRU may send a request for the same set or a subset of DL-RSs used to train the AI/ML model(s) at the WTRU. The WTRU may make measurements on the received DL-RSs during LCM and/or determine the input for an AI/ML model based on the measurements. The WTRU may send a request for measurements from the network. The measurements may be used during the data collection phase to train AI/ML model(s). The WTRU may receive measurements and/or associated ground truth from the network. The WTRU may save measurements and/or a subset of the measurements used during the data collection phase. The WTRU may use the saved set and/or subset of the measurements during the LCM.

A ground truth (e.g., WTRU location) may be associated with the measurements. The WTRU may receive the measurements and/or associated ground truth from the network. The WTRU may save the ground truth and/or associated measurements. The WTRU may receive the ground truth associated with DL-RSs and/or DL-RSs configurations (e.g., satellite ID, and/or DL-RS resource ID).

The WTRU may perform LCM if at least one or combination of the following conditions is satisfied: WTRU speed and/or change in the WTRU location is greater than the configured threshold; satellite speed or Doppler drift in measurements is greater than the configured threshold; the configured weather condition (e.g., cloudy, rainy) is satisfied; distance between satellite(s) is greater than the configured threshold; configured time (e.g., absolute time, relative time with respect to a reference, periodic occasion, and/or time instances); and/or location (e.g., the WTRU is in configured area to perform LCM).

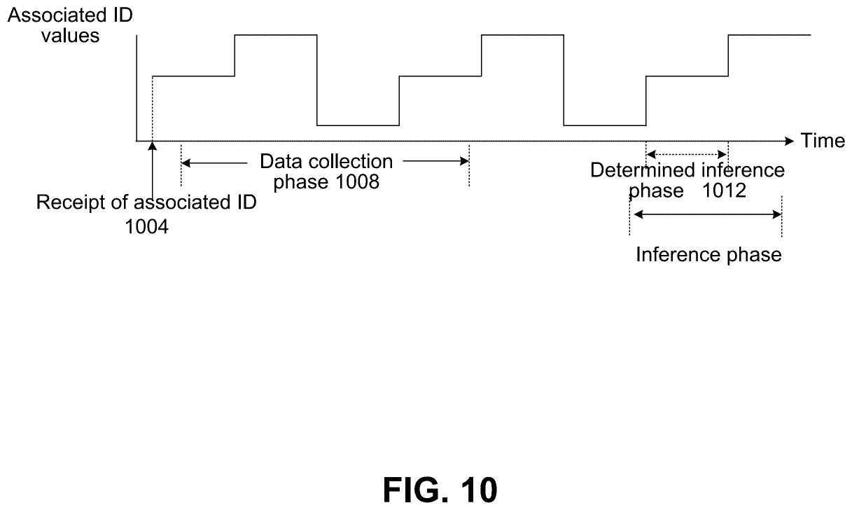

The WTRU may determine consistency between training and/or inference phase based on the associated IDs. For example, the WTRU may receive an associated ID 1004 which varies with time as depicted in FIG. 10. During the data collection phase 1008, the WTRU may train AI/ML model(s) using more than one associated IDs. During the inference phase 1012, the WTRU may be configured with more than one associated IDs. During the inference phase 1012, the WTRU may determine an associated ID that matches with the one of the associated IDs used during the training phase 1008, as seen in FIG. 10. The WTRU may report the associated ID(s) used during training and/or inference phase. The WTRU may report determined conditions (e.g., ephemeris) and/or measurements to the network.

The WTRU may determine that due to the time varying characteristic of the associated ID, the same associated ID used during the training phase cannot be found during the inference phase. In such case, the WTRU may determine that the condition is not consistent and report to the network that consistency cannot be achieved. The WTRU may report inference and/or measurements obtained during the inference phase.

The WTRU may receive an indication from the network an associated ID at which the WTRU should make measurements during training and/or inference phase.

The WTRU may be configured with priority levels for each associated ID value. If the WTRU determines that there are more than one associated IDs that match between the data collection phase and inference phase, the WTRU may determine to select the associated ID based on the configured priority level (e.g., select the associated ID value with the highest priority). The WTRU may determine the priority level based on at least associated area (e.g., cells and/or satellite cells), associated DL-RS configurations (e.g., satellite ID) and/or associated time (e.g., time window and/or duration).

The WTRU may determine that there are more than one associated IDs in common between the data collection phase and inference phase. In such case, the WTRU may determine to choose one associated ID that is common between the data collection phase and inference phase. The WTRU may report, to the network, the associated ID the WTRU chose.

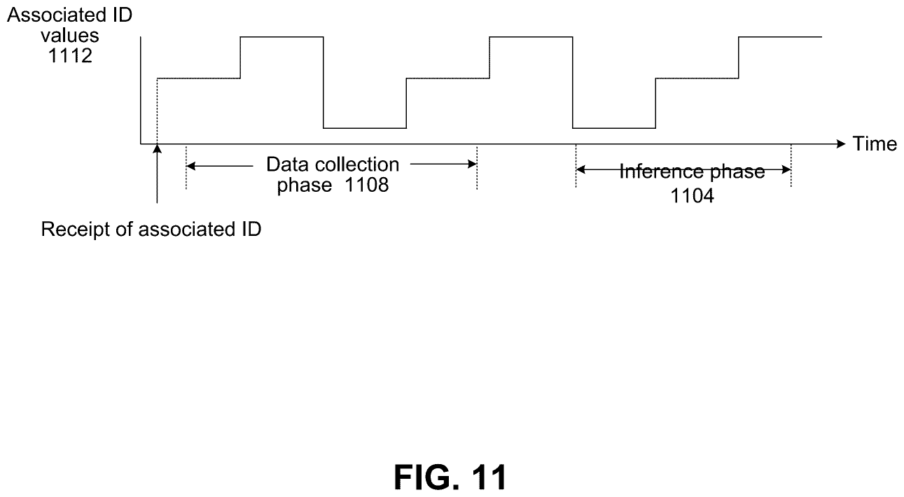

FIG. 11 depicts both the data collection phase and the inference phase covering more than one associated ID. In other words, FIG. 11 depicts where the inference phase 1104 and/or data collection phase 1108 cover more than one associated ID values 1112. The WTRU may determine one associated value during the inference phase based on the configured priority and determine the inference based on the determined associated ID. The WTRU may be configured with more than one associated ID functions. The WTRU may be configured with a priority level (e.g., numerical values indicating priority level such as 1 for low priority, 2 for high priority) for each associated ID function. The WTRU may determine the associated ID functions to use based on the configured priority level (e.g., the WTRU determines to use the associated ID function with the highest priority).

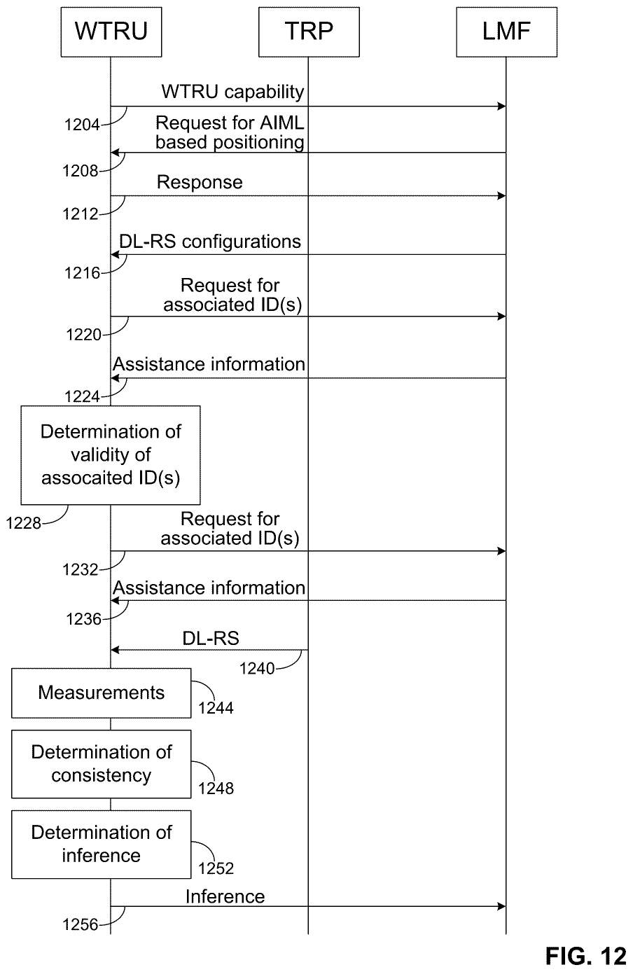

FIG. 12 depicts a call flow indicating signaling between the WTRU and the network. At 1204, the WTRU may send WTRU capability information to the network. The WTRU may receive a request from the network for WTRU capability information. At 1208, the WTRU may receive a request for AI/ML based positioning from the network (e.g., LMF). At 1212, the WTRU may send a response for the request where the response may be “yes” or “no” for the request for AI/ML based positioning. At 1216, the WTRU may receive DL-RS configurations for measurements (e.g., for data collection, training AI/ML model(s), and/or generation of inference using the trained AI/ML model(s)). At 1220, the WTRU may send a request for associated IDs to the network. At 1224, the WTRU may receive assistance information (e.g., associated IDs) from the network. At 1228, the WTRU may determine validity of the received associated IDs based on the configured conditions. At 1232, the WTRU may send a request for associated IDs if a validity condition is not satisfied. At 1236, the WTRU may receive assistance information (e.g., new associated ID(s)) from the network. At 1240, the WTRU may receive DL-RS from TRP(s) (e.g., satellite(s)). At 1244, the WTRU may make measurements on the received DL-RS. At 1248, the WTRU may determine consistency between data collection phase and inference phase. At 1252, if conditions are consistent, the WTRU may generate inference using the trained AI/ML model(s) at the WTRU. At 1256, the WTRU may report the generated Inference (e.g., WTRU location estimated by AI/ML model(s)).

What is claimed is:

1. A wireless transmit/receive unit (WTRU) comprising:
a processor and a memory, the processor configured to:
receive a first associated identifier (ID) function and one or more validation conditions, wherein the first associated ID function is associated with a set of time-varying characteristics of a non-terrestrial network (NTN) communication channel;
determine whether the one or more validation conditions are satisfied;
determine a first set of values associated with the first associated ID function and based on the one or more validation conditions being satisfied and the first associated ID function is associated with a first time period of an artificial intelligence or machine learning (AI/ML) model;
determine a second set of values associated with the first associated ID function and based on the one or more validation conditions being satisfied and the first associated ID function is associated with a second time period of the AI/ML model; and
send a report, wherein the report indicates that the first set of values were used during the first time period of the AI/ML model and that the second set of values were used during the second time period of the AI/ML model.

2. The WTRU of claim 1, wherein the report indicates a consistency between conditions of the first set of values and the second set of values.

3. The WTRU of claim 1, wherein the report indicates a comparison between the first set of values and the second set of values.

4. The WTRU of claim 3, wherein the processor is further configured to:
determine, if the one or more validation conditions are satisfied, the difference of a value of the first set of values and a value of the second set of values;
determine a third value based on the difference between the value of the first set of values and the value of the second set of values; and
send the third value with the report, wherein the third value is the indication of the comparison between the first set of values and the second set of values.

5. The WTRU of claim 1, wherein the processor is further configured to:
send an indication to the network that the first associated ID function is no longer valid or that the one or more validation conditions are not satisfied; and
receive a second associated ID function in response to the indication.

6. The WTRU of claim 1, wherein the processor is further configured to:
send an indication to the network that the first associated ID function is no longer valid or that the one or more validation conditions are not satisfied;
receive reconfigured parameters for the first associated ID function; and
generate a second associated ID function based on the first associated ID function and the reconfiguration parameters.

7. The WTRU of claim 1, wherein the set of time-varying characteristics comprise one or more of transmit reception points (TRPs), atmospheric conditions, weather conditions, power sharing, or the network energy saving (NES) status of a satellite.

8. The WTRU of claim 1, wherein the validation conditions comprise one or more of the difference between two values of the first set of values exceeding a threshold, measurements of downlink reference signals (DL-RS) exceeding a threshold, a validity area associated with the first associated ID function, or a request from a network device to generate an inference under the first associated ID function.

9. The WTRU of claim 1, wherein the WTRU receives a first set of a plurality of associated ID functions and the first associated ID function is one of the first set of a plurality of associated ID functions and each associated ID function of the first set of plurality of associated ID functions is associated with a respective set of time-varying characteristics of the first NTN communication channel.

10. The WTRU of claim 9, wherein the processor is further configured to:
determine a priority level for each associated ID function of the first set of plurality of associated ID functions; and
select a first associated ID function based on the determined priority level.

11. A method implemented by a wireless transmit/receive unit (WTRU), the method comprising:
receiving a first associated identifier (ID) function and one or more validation conditions, wherein the first associated ID function is associated with a set of time-varying characteristics of a non-terrestrial network (NTN) communication channel;
determining whether the one or more validation conditions are satisfied;
determining a first set of values associated with the first associated ID function and based on the one or more validation conditions being satisfied and the first associated ID function is associated with a first time period of an artificial intelligence or machine learning (AI/ML) model;
determining a second set of values associated with the first associated ID function and based on the one or more validation conditions being satisfied and the first associated ID function is associated with a second time period of the AI/ML model; and
sending a report, wherein the report indicates that the first set of values were used during the first time period of the AI/ML model and that the second set of values were used during the second time period of the AI/ML model.

12. The method of claim 11, wherein the report indicates a consistency between conditions of the first set of values and second set of values.

13. The method of claim 11, wherein the report indicates a comparison between the first set of values and the second set of values.

14. The method of claim 13, further comprising:
determining, if the one or more validation conditions are satisfied, the difference of a value of the first set of values and a value of the second set of values;
determining a third value based on the difference between the value of the first set of values and the value of the second set of values; and
sending the third value with the report, wherein the third value is the indication of the comparison between the first set of values and the second set of values.

15. The method of claim 11, further comprising:
sending an indication to the network that the first associated ID function is no longer valid or that the one or more validation conditions are not satisfied; and
receiving a third associated ID function in response to the indication.

16. The method of claim 11, further comprising:
sending an indication to the network that the first associated ID function is no longer valid or that the one or more validation conditions are not satisfied;
receiving reconfigured parameters for the first associated ID function; and
generating a second associated ID function based on the first associated ID function and the reconfiguration parameters.

17. The method of claim 11, wherein the set of time-varying characteristics comprise one or more of transmit reception points (TRPs), atmospheric conditions, weather conditions, power sharing, or the network energy saving (NES) status of a satellite.

18. The method of claim 11, wherein the validation conditions comprise one or more of the difference between two values of the first set of values exceeding a threshold, measurements of downlink reference signals (DL-RS) exceeding a threshold, a validity area associated with the first associated ID function, or a request from a network device to generate an inference under the first associated ID function.

19. The method of claim 11, wherein the WTRU receives a first set of a plurality of associated ID functions and the first associated ID function is one of the first set of a plurality of associated ID functions and each associated ID function of the first set of plurality of associated ID functions is associated with a respective set of time-varying characteristics of the first NTN communication channel.

20. The method of claim 19, further comprising:
determining a priority level for each associated ID function of the first set of plurality of associated ID functions; and
selecting a first associated ID function based on the determined priority level.
